(19) United States
(12) Patent Application Publication
(10) Pub. No.: US 2016/0373149 A1
(43) Pub. Date: Dec. 22, 2016

(54) MOBILE COMMUNICATION SUBSCRIBER MULTIFUNCTION IDENTIFICATION MODULE

(71) Applicant: Vladimir Aleksandrovich ELIN, Moscow (RU)

(72) Inventor: Vladimir Aleksandrovich ELIN, Moscow (RU)

(21) Appl. No.: 15/108,866

(22) PCT Filed: May 16, 2014
(86) PCT No.: PCT/RU2014/000350

§ 371 Date: Jun. 29, 2016

(30) Foreign Application Priority Data
Feb. 10, 2013 (RU) 2013144162

(51) Int. Cl. H04B 1/3816

(52) U.S. Cl. CPC H04B 1/3816

(57) ABSTRACT

A mobile communication subscriber multifunction identification module comprises a switch controller 2 connected to a contact group 1 adapted to be connected to the system bus 10 through, for example, a contact group of a radio device 9, designed for connection of the identification module, a data bus 6 to which a group of 4 to 512 programmable non-volatile read only memory cells 7, an access key storage unit 8 for several mobile communication wireless networks of various standards, for example, GSM, CDMA, UMTS, LTE, and a memory cell 7 switch controller 2 to which a process controller 4 is connected, the switch controller 2 and the data bus 6 being installed on a wafer. The technical result of using the invention consists in enhancing the reliability and improving the conditions of the programming.

### CROSS-REFERENCE TO RELATED APPLICATIONS

The present application is a National stage application from PCT application No. PCT/RU2014/000350 filed on May 16, 2014, which claims priority to Russian patent application RU 2013144162 filed on Feb. 10, 2013.

### FIELD OF INVENTION

The invention relates to devices providing, correct functioning of a mobile device with a personal authorization of services in wireless networks (“UnifiedPersonalResourceAuthorizer”). The device enables operation with a large number of telephone numbers or other ways of identification in a single apparatus (mobile radio device).

### PRIOR ART

An identification carrier is known designed for the cooperation with a telematic unit for identification of the subscriber in the mobile telephone network and comprising a chip the configuration of which enables its personalization and connection to the subscription at the communication means operator side, a support to support the said chip, and connections means undetachably connected to the chip connecting leads and providing their connectibility, the said support being adapted to enclose the chip, and the connections means being adapted to pass to a locator beyond the support, offering connectibility, through the casing, formed thereby. Individual identification carriers are installed at certain distances and in certain positions on a standardized support (RU No. 2461146).

A telephone set is known adapted to use several SIM cards, comprising a means for taking-in a SIM card on which identification number data is stored, with a device for taking-in a SIM card and with a reader device, a means for registration of the said SIM card in the enabling telephone system, using the said identification number, and a processor receiving identification numbers simultaneously with the enabling telephone system in order that calls related to the respective telephone numbers are received by the said telephone, the telephone set is adapted to use several SIM cards, and the telephone set comprises a means for taking-in a SIM card for each additional SIM card on which the information on the one respective identification number is stored, associated with a means for registration of the said SIM card in the enabling telephone system, using its own identification number, and with a reader device connected with the respective inputs of the devices for taking-in a SIM card through a common communication unit, and a common device for communication with an aerial, connected with the respective other inputs of all the devices for taking-in a SIM card (RU No. 27767).

The disadvantages of the known devices include the complexity of the design and insufficient operating speed due to the necessity of using and installing several independent SIM cards in the limited space of a mobile radio device, and initializing the individual controller of each card fur establishing communication in each wireless communication network, as well as lack of functionality, which prevents from selecting, the optimal network out of considerable number of wireless networks and tariffs. Virtually, no reliable protection against unauthorized access is provided.

Group implementations of SIM modules already exist nowadays, supporting the use of and switch between several cellular communication subscriber profiles each with its own telephone number (MSIN) and a combination of keys for identification of the subscriber in the network. The SIM-adapter MagicSim with an integrated MultiSIM card represents a combination of 8 SIM cards, including 2 unreadable cards, in one mobile telephone, with support of SIM-cards operation in 3-rd generation networks—3 G. Such multi SIM cards are generally characterized in a large memory capacity in the card itself as compared with a conventional card, as well as in providing a special software in the card, enabling switching of subscriber profiles. Optional functions are also supported, IP-telephony, for example. The main purpose of such cards consisted in the cloning of SIM cards produced earlier, as well as combining of them in a single module (Web-site http://multi-sim.ru/index.php?productID=7, prototype)

The disadvantage of the known technical solution consists in a low reliability and complicated programming, as it has the only enhanced non-volatile memory cell (divided into sections for 8 SIM cards) which prevents a correct addressing of each operator. The known solution does not support access to Wi-Fi networks. The IP-telephony information is stored in the memory of the telephone itself and is lost when changing as telephone.

### SUMMARY OF THE INVENTION

The engineering problem of the invention consists in providing an effective mobile communication subscriber multifunction identification module.

The technical result of using the invention consists in enhancing the reliability and improving the conditions of the programming tanks to the file that a subscriber profile is kept in each cell and a correct addressing of each operator is provided thanks to the formation of one-channel identification modules that do not affect each other, with independent memory cells and self-contained software.

In addition, the invention enables simplifying of the design and speeding, as well as enhancement for selection of the optimum option of the maximum possible number of wireless networks and tariffs, and for protection against unauthorized use.

The essence of the invention is that a mobile communication subscriber multifunction identification module comprises a programmable switch controller connected to a contact group adapted to be connected to the system bus of a mobile radio device, designed for connection of the identification module, a data bus to which a group of non-volatile memory cells, an access key storage unit for several mobile communication wireless networks, and a memory cell switch controller to which a process controller is connected, adapted to form temporary one-channel identification modules with any of the said memory cells, the programmable switch controller and the data bus being installed on a wafer.

Preferably, the module is furnished with a user identification unit connected to the switch controller and adapted to store social data and biometric identity regarding the subscriber, each non-volatile memory cell represents a fill-function read only memory cell for SIM cards, the non-volatile memory cells are adapted to store keys for access to the available GSM, Wi-Fi, NFC, Bluetooth wireless communication networks, and the controllers are made as 8-bit processors.

The module can be made as an integrated-circuit component housed in a plastic package, and the substrate is made as a Wafer made of elastic plastic, for example, of polyimide or two-layer textolite, and furnished with a NFC antenna connected to the switch controller. With that, the module is made as a plug-in card adapted to be installed and replaced in the casing of a mobile device.

Otherwise, the module can be made as an integrated-circuit integrated in a mobile radio device.

### SHORT DESCRIPTION OF DRAWINGS

FIG. 1 illustrates the basic block diagram of the mobile communication subscriber plug-in multifunction identification module, and FIG. 2 illustrates the diagram for the installation of the plug-in identification module as per FIG. 1 in a mobile radio device, and FIG. 3 the diagram for arrangement of the module as per FIG. 1, made as a module integrated in a mobile radio device.

UnifiedPersonalResourceAuthorizer” (UPRA) mobile communication subscribermultifunction identification module comprises a switch controller 2 connected to a contact group 1 adapted to be connected to the system bus 10 through, for example, a contact group of a mobile radio device 9, designed for connection of the identification module, a data bus 6 to which a group of 4 to 512 programmable non-volatile read only memory cells 7, an access key storage unit 8 for several mobile communication wireless networks of various standards, for example, GSM, CDMA, UMTS, LTE, and the said memory cell 7 switch controller 2 to which a process controller (SIM controller) 4 is connected, the switch controller 2 and the data bus 6 being installed on a wafer (not shown). The controller 4 is adapted to form temporary (alternate) one-channel identification modules with any of the said memory cells 7. The bus 5 can represent an interface for interworking with multiple memory cells 7 and can be made as an additional controller, for example/ The contact group 1 in FIG. 2 is identical to the contacts of a conventional SIM card, that is it provides physical compatibility with telephones currently in general use.

The module is furnished with a social data unit 3 connected to the switch controller 4 and adapted to store social data and biometric identity regarding the subscriber (a photo, finger mark, iris scan) in the digitized form, and to identify the user. The unit 3 can represent a dedicated memory cell of a volume larger than the SIM card memory cell 7, with the possibility to store access keys to Wi-Fi networks; a list of masted networks; IP telephony access keys and settings; subscriber electronic signature certificates and keys.

Each non-volatile memory cell 7 represents a 32 to 64 kB EEPROM or NVRAM full-function memory cell for SIM cards.

The memory cells 7 are adapted to store keys for access to the available GSM, Wi-Fi, NFC, Bluetooth wireless communication networks. Each memory cell 7 stores keys for access to one of the wireless communication networks, and the controller 4 saves information on the possibility of access to one of the said networks for each of cells 7.

The switch controller 2 is made as a 8-bit controller with a microroutine processing signals from the contact group 1, coming from the user interface (from a keyboard, for example) of a mobile radio device (smartphone). The switch controller 4 is made as a 8-bit controller with a microroutine too.

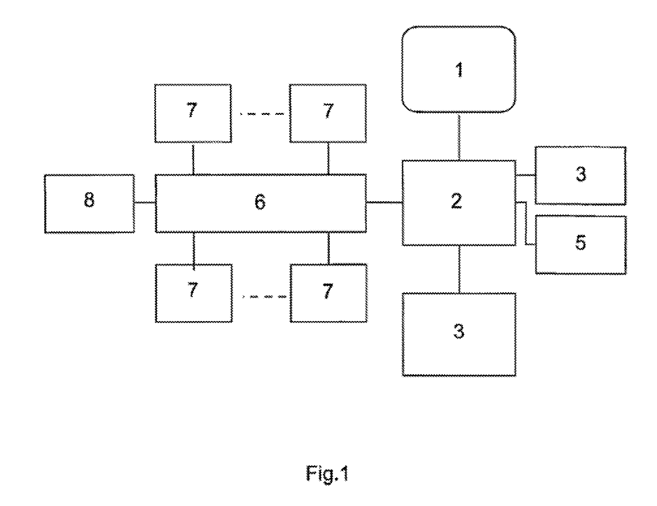

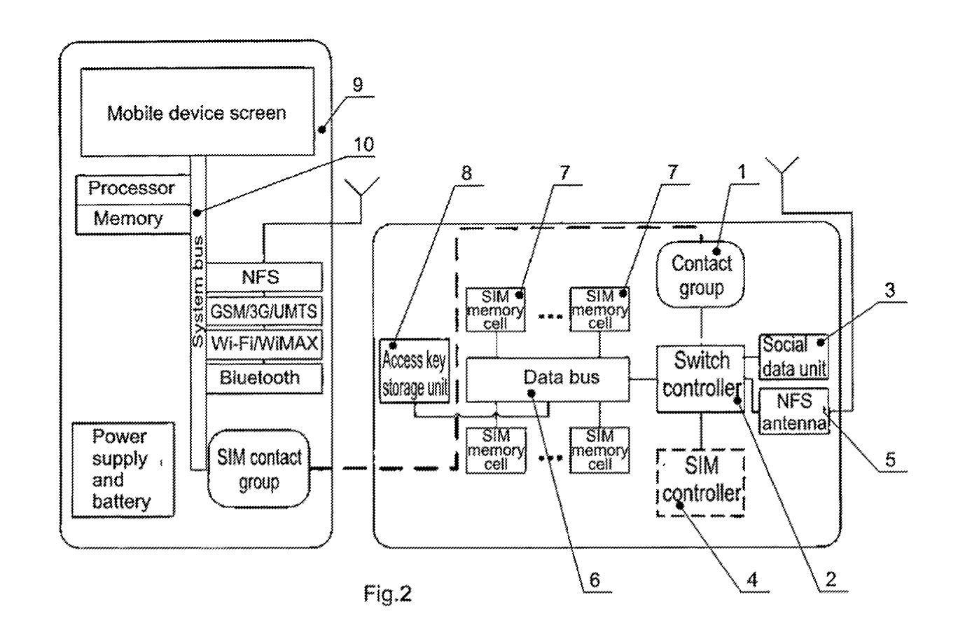

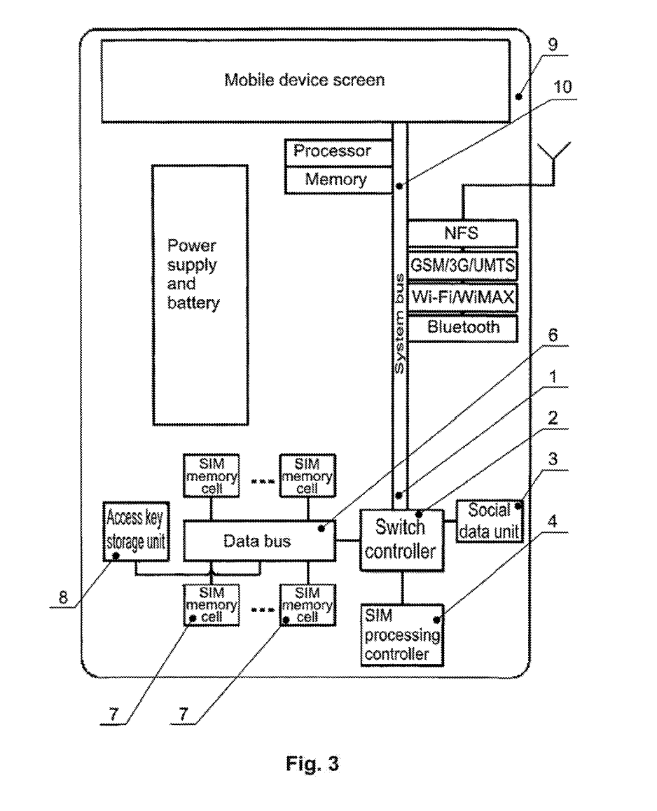

The module can be made as a plug-in integrated-circuit component housed in a plastic package, and the substrate is made as a wafer made of elastic plastic, for example, of polyimide or two-layer textolite. With that, the super-Virtual-SIM version of the module is made in accordance with FIG. 1, 2 as a plug-in card dimensioned as a standard SIM card, to be installed and/or replaced in the carrier (slot) of the casing of a mobile radio device 9. Preferably, the super-Virtual-SIM version of the module is furnished with a NFC (NearFieldCommunication) antenna 5 connected to the controller 2.

In this case, the module is dimensioned 25×15 ×0.76 mm and has a bevelled corner (for positioning the card in the slot). Also, module versions are available dimensioned in the Micro-SIM format 15×12 ×0.76 mm, or in the Nano-SIM format 12.3×8.8×0.67 mm.

Otherwise, the super-Phone-Service version of the module can be made as an integrated-circuit integrated in a mobile radio device in accordance with FIG. 3, that is forming an integral part of the mobile radio device 9. In such cases the contact group 1 is immediately connected to (or integrated in) the system bus 10 of the mobile radio device 9 which is connected with GSM, Wi-Fi, Bluetooth wireless networks and NFC antenna, NFC.

The below Table compares a conventional SIM card with the claimed UPRA module.

TABLE

| SIM card | UPRA module |
|---|---|
| One 8-bit processor | Two 8-bit processors (controllers 2, 4) |
| A single data area for | Multiple data areas (cells 7) for |
| storing information | storing information on services |
| on services provided. | provided. |
| | Access key storage unit 8 for |
| | wireless networks |
| | IP-telephony is supported |
| | Social data unit 3 (biometrics, |
| | physical access keys) |
| | Switch controller 2 made as a separate |
| | controller connected to process |
| | controller 4 of SIM card |
| | Integrated NFC antenna 5 |

### DETAILED DESCRIPTION OF THE INVENTION

### Preferred Embodiment

The “UnifiedPersonalResourceAuthorizer” (UPRA) mobile communication subscriber module (UPRA) operates as follows,

A user's mobile terminal (device)—a telephone, smartphone table computer, computer—is used as the interface for module interworking with the user, having the respective software for interworking with controller 2. On the radio device 9 mobile terminal, the user generates commands which are transmitted to the module through contact group 1.

The optimal cost and/or quality of communication or the user's wish is the criterion for selecting the current active number (operator), when several radio channels are provided in the device.

The subscriber changes from the availability area of one operator (billing plan).

The subscriber selects a desirable operation on the screen of its mobile device (change of the operator or tariff, traffic upload m the Wi-Fi, IP call, etc.), generates a command for the switch controller 2 and sends it to the controller 2 for processing through either the communication system bus 6 or contact group 1.

The switch controller 2 implements the communication operator selection logics. To do that, it receives status signals and external connection presence signals from the mobile radio device 9 through the contacts of the group 1, and takes a decision on the selection of the communication provider, IP-telephony channel, or Wi-Fi access point for transmission of voice and data, based on the microroutine stored in memory area independent of the areas storing information on services provided and social data unit 3.

The switch controller 3 demodulates user commands, determines if they relate to the control signals for the device (change of the operator, billing plan, access to data in the social data unit 3 or access key storage unit 8) or to the control signals of the mobile communication network (make a network logon or call) and either performs an action to change the operator or access the data of one of the units 3 or 8, or transfers a processing command to the SIM processing controller 4 to make a network logon or call, and returns the result to the telephone via the contact group 1.

In accordance with its microroutine, the switch controller 2 performs the user action (selects and changes the SIM active memory cell 7 of one operator for the cell 7 of a different operator, changes the billing plan, gets connected to Wi Fi, using, as key from the access key storage unit 8 etc.) and returns the result via the bus 6 or contact group 1 for displaying it to the subscriber on the telephone screen,

The SIM processing, controller 4 handles the data of that SIM memory cell 7 which is currently selected by the controller 2 as an active cell, based on the analysis of the user location, the presence of signals from various sources, and data on the available billing plans. When a command comes for communication operator or tariff change, the switch controller 2 specifies the respective cell 7 to the processing SIM controller 4 as an active cell. When a specific memory cell 7 is selected and initialized for forming a one-channel identification module, the SIM processing controller 4 handles its data as if it were a single SIM card. In doing that, the mobile device operates for the user so, as it would operate if one-channel SIM cards were present.

The processing controller 4 can interact with the NFC antenna 5, using an access protocol, similarly to a one-channel module (SIM card) operating with contact NFC antennas mounted on the card contacts.

The data from the social data unit 3 can be accessible directly through the NFC antenna 5 for reading so that it can be presented in a devoted terminal as an alternative to the passport when the subscriber physically accesses buildings, when rendering bank or other services etc. In doing that, a copy of the data, available in unit 3, is compared with the sample obtained from the user (a scan of the finger mark, visual inspection, identification of a photo).

This module, that is a UPRA module, is not only a SIM card emulator, but also comprises a set of digital keys and their representation and transfer techniques through Wi-Fi, NFC, Bluetooth, using an electronic protocol, fix the respective communication services and wireless techniques, and is suitable for storing keys to locks of doors of guarded buildings.

The UPRA provides support and expansion of services provided by the cellular communication operator (operators), that is it is a module covering all various interesting extensions of existing SIM cards.

As a result, the specified UPRA module represents a device representing a storage element fort a large number of SIM emulators or other digital data required for authorization in various wireless technologies and electronic services. The controller 4 supports the functionality required for the selection and use of SIM 7 cells and respective wireless resources. The suggested implementation of the UPRA module enables a telephone to operate simultaneously with one or several telephone numbers at option. The number of simultaneously active telephone numbers is equal to the number of independent radio channels in the telephone.

The UPRA module virtually removes a limit for the number of SIM cards in a telephone (according to the number of cells 7), but also it is a personal storage device for access keys to wireless data transfer networks, smart switches of active network connections, a storage location for social data, which considerably enhances the usability properties of modern telephones.

Access to SIM cards memory cells 7 and social data unit 3 can be programmatically delimited so that the data from the social data unit 3 can only be used through NFC or Bluetooth, but not through the interface of a mobile telephone in order to ensure their security for example, in such a manner you can separate physical access keys for a bank cell from VAS (additional services) of the communication operator.

As no need exists in such cases for manufacturing, programming additional SIM cards, and their transferring to the user as a physical product, then the respective costs are removed for companies providing wireless access services. Connection to wireless access services can be established based on the association of the access key with the “fingerprint” of a telephone or smartphone. Nowadays, many techniques exists for forming “fingerprints” of devices of such a complexity level. For example, the user obtains the respective key from the company providing wireless access services when making a wireless services contract. Then, the user enters that key in response to the operator networking request after initiating the service refreshing procedure. The refreshed key is “associated” with the “fingerprint” of the user device, and the device can get access to the services of the operator. An attempt at refreshing a key that is already used from an outsider can bring about some aftermath to the outsider. When a telephone number or a package of services is transferred from one device to another, the user contacts the respective operator who initializes a software procedure of request to the device for deleting the specified service from its set. Next, the checkbox of the service to be provided is associated with the newly generated key, and the user conducts a refreshing procedure on the other device.

The above procedure seems to be a little excessive, but completely reliable, when a task is set not to transfer the user device to the representative of operator providing wireless access services. But, if the operator is given the authority to read the device “fingerprint”, then the procedure for providing the service or transferring the service to another device or the procedure for canceling the service can be performed by the operator's representative without the participation of the user, which seems to be more convenient.

The technical result of using the invention (which can be called “Unified Personal Wireless Resource Authorizer” in the English language) consists in enhancing the reliability and improving the conditions of the programming tanks to the fact that a subscriber profile is kept in each cell and a correct addressing of each operator is provided thanks to the formation of one-channel identification modules that do not affect each other, with independent memory cells and self-contained software.

Besides, you must take into account simplifying of the design and speeding, as well as enhancement for selection of the optimum option of the maximum possible number of wireless networks and tariffs, and for protection against unauthorized use. Additionally, the invention provides support and expansion of services provided by the cellular communication operator (operators), that is it is a module covering all various interesting extensions of existing SIM cards.

### INDUSTRIAL APPLICATIONS

The present invention is embodied with multipurpose equipment extensively employed by the industry.

1. A mobile communication subscriber multifunction identification module comprising a programmable switch controller connected to a contact group adapted to be connected to the system bus of a mobile radio device, designed for connection of the identification module, a data bus to which a group of non-volatile memory cells, an access key storage unit for several mobile communication wireless networks, and a memory cell switch controller to which a process controller is connected, adapted to form temporary one-channel identification modules with any of the said memory cells, the programmable switch controller and the data bus being installed on a wafer.

2. A module according to claim 1, characterized in that it is furnished with a user identification unit connected to the switch controller and adapted to store social data and biometric identity regarding the subscriber.

3. A module according to any claim 1, 2, characterized in that each non-volatile memory cell represents a hill-function cell of SIM card read only memory.

4. A module according to any claim 1, 2, characterized in that the non-volatile memory cells are adapted to store keys for access to the available GSM, NFC, Bluetooth wireless communication networks.

5. A module according to any claim 1, 2, characterized in that the switch and process controllers are made as 8-bit processors.

6. A module according to an claim 1, 2, characterized in that it is made as an integrated-circuit component housed in a plastic package, and the substrate is made as a wafer made of elastic plastic, for example, of polyimide or two-layer textolite.

7. A module according to claim 6, characterized in that it is furnished with a NFC antenna connected to the switch controller.

8. A module according to claim 6, characterized in that it is made as a plug-in card adapted to be installed and replaced in the casing of a mobile device.

9. A module according to any claim 1, 2, characterized in that it is made as an integrated-circuit integrated in a mobile radio device.
